(19) United States
(12) Patent Application Publication
(10) Pub. No.: US 2007/0018921 A1
(43) Pub. Date: Jan. 25, 2007

(54) Liquid crystal display device

(75) Inventors: Toshiaki Yoshihara, Kawasaki (JP); Tetsuya Makino, Kawasaki (JP); Shinji Tadaki, Kawasaki (JP); Hironori Shiroto, Kawasaki (JP); Yoshinori Kiyota, Kawasaki (JP); Shigeo Kasahara, Kawasaki (JP); Keiichi Betsui, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/527,221

(22) Filed: Sep. 26, 2006

Related U.S. Application Data
(63) Continuation of application No. PCT/JP04/07975, filed on Jun. 8, 2004.

(51) Int. Cl. G09G 3/36

(52) U.S. Cl. 345/88

(57) ABSTRACT

Within one sub-frame or one frame, values of an application voltage of one polarity and an application voltage of the other polarity, and respective retention periods are different. The value of the application voltage of the polarity when dark displaying is carried out is set to be greater than the value of the application voltage of the polarity when bright displaying is carried out, and the retention period thereof is set to be shorter. When the value of the application voltage of the one polarity (the polarity when the bright displaying is carried out correspondingly to a display data) is assumed to be V1, the retention period thereof is assumed to be T1, the value of the application voltage of the other polarity (the polarity when the dark displaying is carried out) is assumed to be V2 and the retention period thereof is assumed to be T2, the value of (V1·T1)/(V2·T2) is set to be in a range between 0.7 and 1.3 and preferably set to be in a range between 0.9 and 1.1.

This application is a continuation of PCT International Application No. PCT/JP2004/007975, which has an International filing date of Jun. 8, 2004, which designated the United States of America.

### TECHNICAL FIELD

The present invention relates to a liquid crystal display device and more particularly relates to a liquid crystal display device of an active drive type that uses a switching element, such as TFT (Thin Film Transistor) and the like.

### BACKGROUND ART

Along with the recent development of so-called information-oriented society, electronic apparatuses represented by a personal computer and a PDA (Personal Digital Assistant) have been widely used. With the spread of such electronic apparatuses, the demand for a portable type that can be used in offices as well as outdoors has been generated, and the smaller-size and lighter-weight thereof has been requested. As one of means to satisfy such purposes, the liquid crystal display device is widely used. The liquid crystal display device is the indispensable technique not only for the smaller size and lighter weight thereof, but also for the smaller power consumption of the portable electronic apparatus driven by a battery.

The liquid crystal display device is roughly classified into a reflection type and a transmission type. The reflection type is designed such that light-rays incident from the front of a liquid crystal panel are reflected by the rear of the liquid crystal panel, and an image is visualized through the reflected light, and the transmission type is designed such that the image is visualized through the transmitted light from a light source (back-light) placed on the rear of the liquid crystal panel. The reflection type is poor in visibility because an environmental condition causes the reflected light amount to be inconstant. Thus, in particular, as the display device of the personal computer for carrying out full-color displaying and the like, typically, the color liquid crystal display device of the transmission type which uses color filters is used.

As the color liquid crystal display device, presently, an actively-driven liquid crystal display device that uses a switching element such as TFT and the like is widely used. Although the liquid crystal display device of this TFT drive is relatively high in display quality, the light transmittance of the liquid crystal panel is low at only several percent at present. Thus, in order to obtain a high screen brightness, the back-light of a high brightness is required. For this reason, the power consumption caused by the back-light becomes great. Moreover, this has a problem that the responsiveness to the electric field of the liquid crystal is slow, and the response speed, especially, the response speed in a half tone is slow. Also, since this is the color displaying that uses the color filters, one pixel must be composed of three sub-pixels. Also, the displaying of a high resolution is difficult, and its displayed color purity is not sufficient.

In order to solve such problems, the present inventor et al. developed a liquid crystal display device of a field-sequential type (for example, refer to non-patent documents 1, 2, 3 and the like). The liquid crystal display device of this field-sequential type does not require the sub-pixels, as compared with the liquid crystal display device of the color-filter type. Thus, the displaying with the higher resolution can be easily realized. Also, without any use of the color filters, the light emission color of a light source can be used in its original state for the displaying. Hence, this is superior in the display color purity. Moreover, since the light utilization efficiency is also high, this has a merit that the power consumption is small. However, in order to realize the liquid crystal display device of the field-sequential type, the high speed responsiveness (2 ms or less) of the liquid crystal is essential.

So, in order to attain the higher speed responsiveness of the liquid crystal display device of the field sequential type or the liquid crystal display device of the color filter type that has the foregoing excellent merits, the present inventor et al. is researching and developing the drive through a switching element, such as TFT and the like, of the liquid crystal, such as a ferroelectric liquid crystal and the like, which has a spontaneous polarization that may be expected to exhibit the speed responsiveness higher by 100 to 1000 times than that of the prior art (for example, refer to a patent document 1 and the like). In the ferroelectric liquid crystal having the spontaneous polarization, liquid crystal molecules are arranged substantially parallel to a substrate, and the long-axis direction of their liquid crystal molecules is changed by a voltage application. Then, the liquid crystal panel sandwiching the ferroelectric liquid crystal material therein is sandwiched between two polarization plates whose polarization axes are orthogonal to each other, and the birefringence caused by the change in the long-axis direction of the liquid crystal molecules is used, thereby changing the transmission light intensity.

[Patent Document 1] Japanese Patent Application Laid Open (No. 11-119189 (1999))

[Non-Patent Document 1] T. Yoshihara et al., (ILCC 98) P1-074, issued in 1998

[Non-Patent Document 2] T. Yoshihara et al., (AM-LCD'99 Digest of Technical Papers,), p. 185, issued in 1999

[Non-Patent Document 3] T. Yoshihara et al., (SID'00 Digest of Technical Papers,), p. 1176, issued in 2000

### DISCLOSURE OF THE INVENTION

The liquid crystal display device of the field sequential type or the liquid crystal display device of the color filter type as mentioned above is desired to attain the smaller power consumption and the lower cost, in the utilization to the portable electronic apparatuses of the battery drive.

FIG. 1 and FIG. 2 are views showing the drive sequence of the liquid crystal display device of the conventional field sequential type, especially the liquid crystal display device of the conventional field sequential type that uses the liquid crystal material exhibiting the electro-optic response characteristic of the half-V-shape as shown in FIG. 3. FIG. 1(a) and FIG. 2(a) show the scan timings of the respective lines of the liquid crystal panel, and FIG. 1(b) and FIG. 2(b) show the timings when the respective colors of red, green and blue of the back-light are lighted up.

One frame is divided into 3 sub-frames. For example, as shown in FIG. 1(b) and FIG. 2(b), the red light is emitted in the first sub-frame, the green light is emitted in the second sub-frame, and the blue light is emitted in the third sub-frame. On the other hand, as shown in FIG. 1(a) and FIG. 2(a), the two image data write scannings are performed on the liquid crystal panel, in the sub-frames of the respective colors of red, green and blue. In the first data scanning, the data scanning is performed at the polarity that enables bright displaying. In the second data scanning, the voltage whose polarity is opposite to the first data scanning and whose value is substantially equal thereto is applied. In the example shown in FIG. 2, as compared with the example shown in FIG. 1, the time necessary for one data scanning is made shorter, and as shown in FIG. 1(b), the back-light is not always lighted up in the sub-frame. Then, the period while the back-light is lighted up is assumed to be the period between the start of the first data scanning and the completion of the second data scanning (FIG. 2(b)). Consequently, the reduction in the power consumption is attempted.

FIG. 4 and FIG. 5 are views showing the drive sequence of the liquid crystal display device of the conventional color filter type, especially, the liquid crystal display device of the conventional color filter type that uses the liquid crystal material exhibiting the electro-optic response characteristic of the half-V-shape as shown in FIG. 3. FIG. 4(a) and FIG. 5(a) show the scan timings of the respective lines of the liquid crystal panel, and FIG. 4(b) and FIG. 5(b) show the timings when the back-light is lighted up.

As shown in FIG. 4(a) and FIG. 5(a), the two image data write scannings are performed on the liquid crystal panel, in each frame. In the first data write scanning, the data write scanning is performed at the polarity that enables the bright displaying. In the second data write scanning, the voltage whose polarity is opposite to the first data write scanning and whose value is substantially equal thereto is applied. In the example shown in FIG. 5, as compared with the example shown in FIG. 4, the time necessary for one scanning is made shorter, and as shown in FIG. 4(b), the back-light is not always lighted up in the frame. Then, the period while the back-light is lighted up is assumed to be the period between the start of the first data scanning and the completion of the second data scanning (FIG. 5(b)). Consequently, the reduction in the power consumption is attempted.

In the liquid crystal display device of the conventional field sequential type or the liquid crystal display device of the color filter type, the value (V1) of the voltage of one polarity inside one sub-frame or inside one frame is equal to the value (V2) of the voltage of the other polarity. Also, when the period between the time after the voltage of one (or the other) polarity is applied to the liquid crystal material and the time until the voltage of the other (or one) polarity is next applied to the liquid crystal material, in other words, the period between the timing when the voltage of one (or the other) polarity is applied and the timing when the voltage of the other (or one) polarity is applied is referred to as a retention period, a retention period (T1) of the voltage of the one polarity inside one sub-frame or inside one frame is equal to a retention period (T2) of the voltage of the other polarity.

Thus, when the scan cycle of the data is assumed to be 50% of one sub-frame or one frame (FIG. 1, FIG. 4), only about half (50%) of the light emission quantity of the back-light can be used for the displaying. Also, even when the scan cycle of the data is assumed to be 25% of one sub-frame or one frame (FIG. 2, FIG. 5), only about ⅔ (67%) of the light emission quantity of the back-light can be used for the displaying.

Hence, in order to attain the smaller power consumption and the lower cost, the improvement of the light usage efficiency of the back-light is desired.

The present invention is proposed in view of such circumstances. It is therefore an object of the present invention to provide the liquid crystal display device that can increase the light usage efficiency of the back-light and attain the smaller power consumption and the lower cost.

In a liquid crystal display device according to a first aspect is a liquid crystal display device in which a liquid crystal material is sealed in gap composed of a plurality of substrates and which applies voltage whose polarities are different, to the liquid crystal material, plural times within a predetermined period, and this is characterized in that a value of the voltage of one polarity that is applied to the liquid crystal material within the predetermined period is different from a value of the application voltage of the other polarity, and a period until the application of the voltage of the other polarity after the application of the voltage of the one polarity is different from a period until the application of the voltage of the one polarity after the application of the voltage of the other polarity.

In the first aspect, within one sub-frame or one frame, the values of the application voltage of the one polarity and the application voltage of the other polarity, and respective retention periods are made different. Thus, the light usage efficiency of the back-light can be improved.

The liquid crystal display device according to a second aspect is characterized in that the value of the voltage of the other polarity when dark displaying is carried out is greater than the value of the voltage of the one polarity when bright displaying is carried out and the period until the application of the voltage of the one polarity after the application of the voltage of the other polarity is shorter than the period until the application of the voltage of the other polarity after the application of the voltage of the one polarity.

In the second aspect, the application voltage of the polarity at which the dark displaying is carried out is designed such that the value is greater and the retention period is shorter, as compared with the application voltage of the polarity at which the bright displaying is carried out. Thus, in the period while the back-light is lighted up, the period of the dark displaying that can be regarded to be a black image, namely, the period while the back-light that does not contribute to the displaying is lighted up can be made shorter. Hence, the light usage efficiency of the back-light is further improved.

The liquid crystal display device according to a third aspect is characterized in that V1·T1≈V2·T2 is satisfied.

V1: the value of the voltage of the one polarity

T1: the period until the application of the voltage of the other polarity after the application of the voltage of the one polarity

V2: the value of the voltage of the other polarity

T2: the period until the application of the voltage of the one polarity after the application of the voltage of the other polarity.

In the third aspect, when the value of the application voltage of the one polarity is assumed to be V1, the retention period thereof is assumed to be T1, the value of the application voltage of the other polarity is assumed to be V2 and the retention period thereof is assumed to be T2, the values of V1·T1 and V2·T2 are made approximately equal. Thus, the imbalance of charges between the time of the voltage application of the one polarity and the time of the voltage application of the other polarity can be suppressed, thereby protecting the image sticking.

The liquid crystal display device according to a fourth aspect is characterized in that 0.7≦(V1·T1)/(V2·T2)≦1.3 is satisfied.

V1: the value of the voltage of the one polarity

T1: the period until the application of the voltage of the other polarity after the application of the voltage of the one polarity

V2: the value of the voltage of the other polarity

T2: the period until the application of the voltage of the one polarity after the application of the voltage of the other polarity.

In the fourth aspect, when the value of the application voltage of the one polarity is assumed to be V1, the retention period thereof is assumed to be T1, the value of the application voltage of the other polarity is assumed to be V2 and the retention period thereof is assumed to be T2, the value of (V1·T1)/(V2·T2) is set to be in the range between 0.7 and 1.3. Thus, the imbalance of the charges between the time of the voltage application of the one polarity and the time of the voltage application of the other polarity can be suppressed, thereby protecting the image sticking.

The liquid crystal display device according to a fifth aspect is characterized in that 0.9≦(V1·T1)/(V2·T2)≦1.1 is satisfied.

V1: the value of the voltage of the one polarity

T1: the period until the application of the voltage of the other polarity after the application of the voltage of the one polarity

V2: the value of the voltage of the other polarity

T2: the period until the application of the voltage of the one polarity after the application of the voltage of the other polarity.

In the fifth aspect, when the value of the application voltage of the one polarity is assumed to be V1, the retention period thereof is assumed to be T1, the value of the application voltage of the other polarity is assumed to be V2 and the retention period thereof is assumed to be T2, the value of (V1·T1)/(V2·T2) is set to be in the range between 0.9 and 1.1. Thus, the image sticking can be more suppressed.

The liquid crystal display device according to a sixth aspect is characterized in that the liquid crystal material is the liquid crystal material having a spontaneous polarization.

In the sixth aspect, the liquid crystal material exhibits the spontaneous polarization. Since the liquid crystal material having the spontaneous polarization is used, the high speed response can be attained, thereby obtaining the high moving image display characteristic and carrying out the displaying based on the field sequential type. In particular, since the ferroelectric liquid crystal material whose spontaneous polarization value is small is used, the drive through a switching element such as TFT and the like becomes easy.

The liquid crystal display device according to a seventh aspect is characterized in that the color displaying is carried out by using the field sequential method.

In the liquid crystal display device according to the seventh aspect, the field sequential method for switching the plurality of colors with time is used to carry out the color displaying. Thus, the color displaying having the high resolution, the high color purity and the high speed response characteristic can be attained.

The liquid crystal display device according to an eighth aspect is characterized in that the color displaying is carried out by using the color filter method.

In the liquid crystal display device according to the eighth aspect, the color filter method using the color filter is used to carry out the color displaying. Thus, the color displaying can be easily performed.

In the liquid crystal display device of the present invention, within one sub-frame or within one frame, the values of the application voltage of the one polarity and the application voltage of the other polarity, and the respective retention periods are made different. Thus, the light usage efficiency of the back-light can be improved. As this result, it is possible to attain the smaller power consumption and the lower cost.

### BRIEF DESCRIPTION OF THE DRAWINGS

FIG. 1 is a view showing one example of a drive sequence of a liquid crystal display device of a conventional field sequential type;

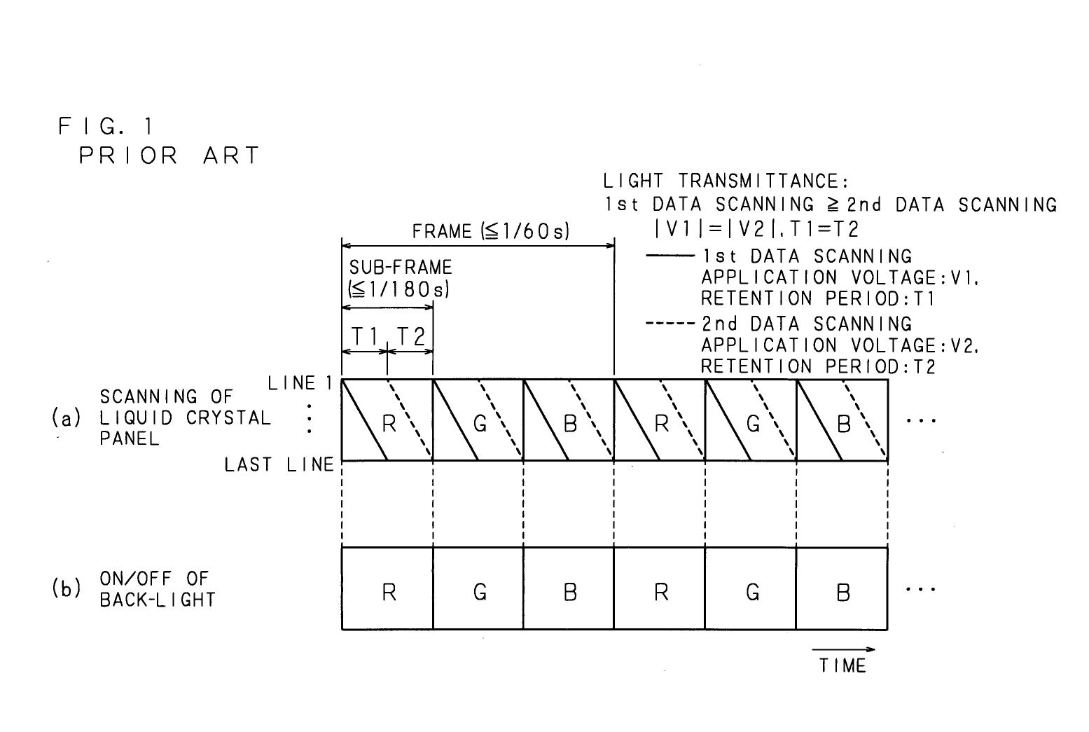

FIG. 2 is a view showing another example of the drive sequence of the liquid crystal display device of the conventional field sequential type;

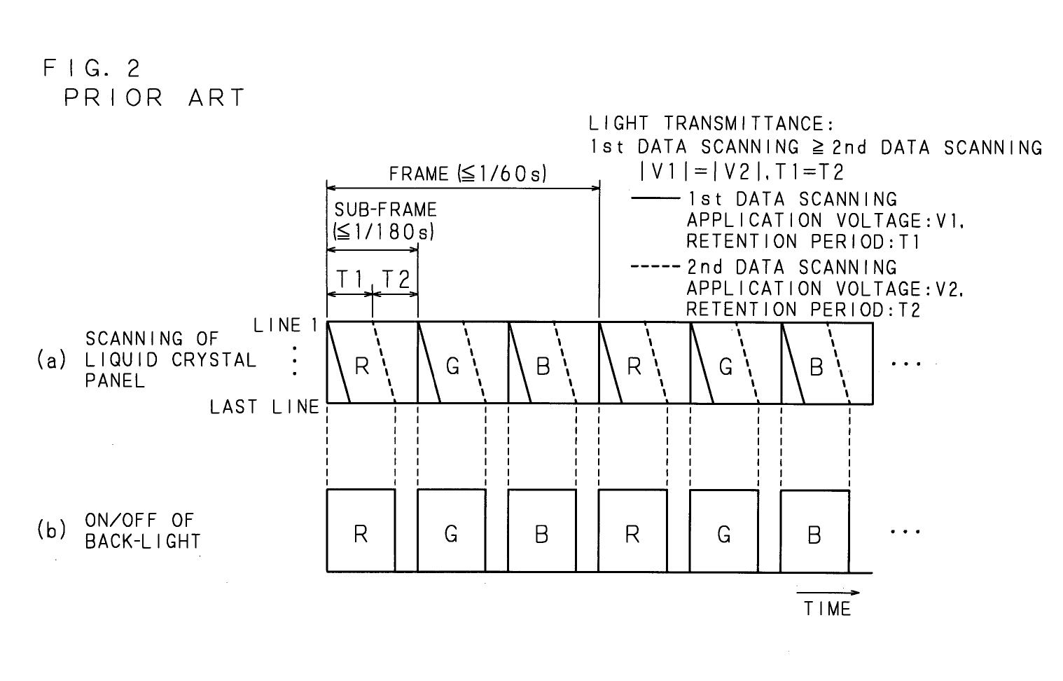

FIG. 3 is a view showing an electro-optic response characteristic (half-V-shape characteristic) of the liquid crystal material;

FIG. 4 is a view showing one example of a drive sequence of a liquid crystal display device of a conventional color filter type;

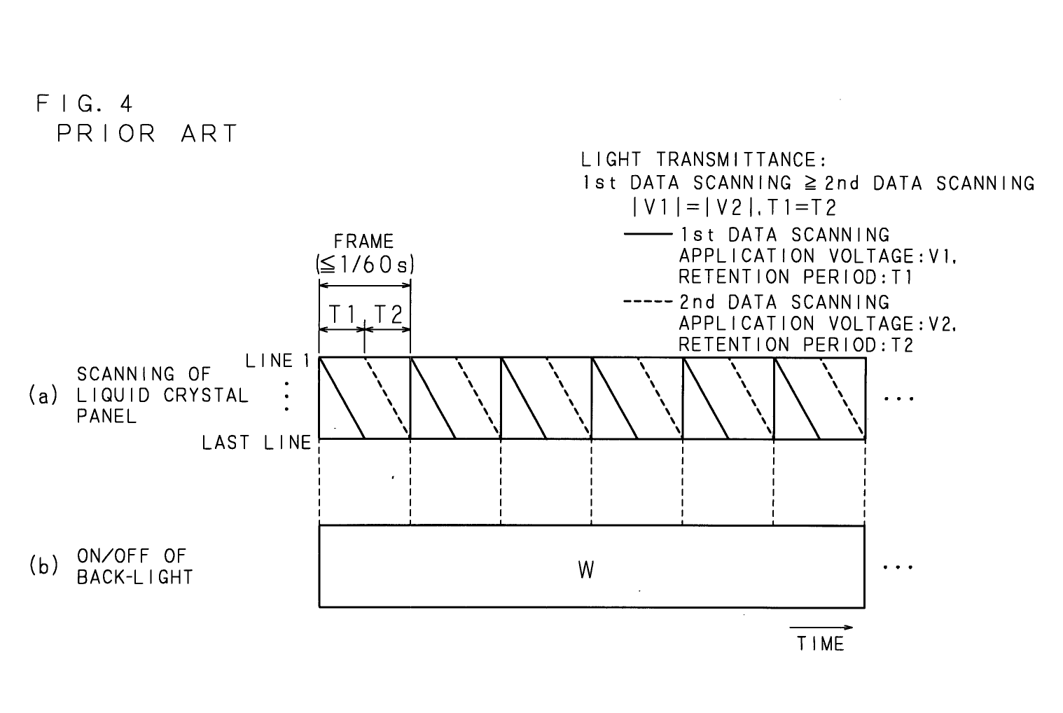

FIG. 5 is a view showing another example of the drive sequence of the liquid crystal display device of the conventional color filter type;

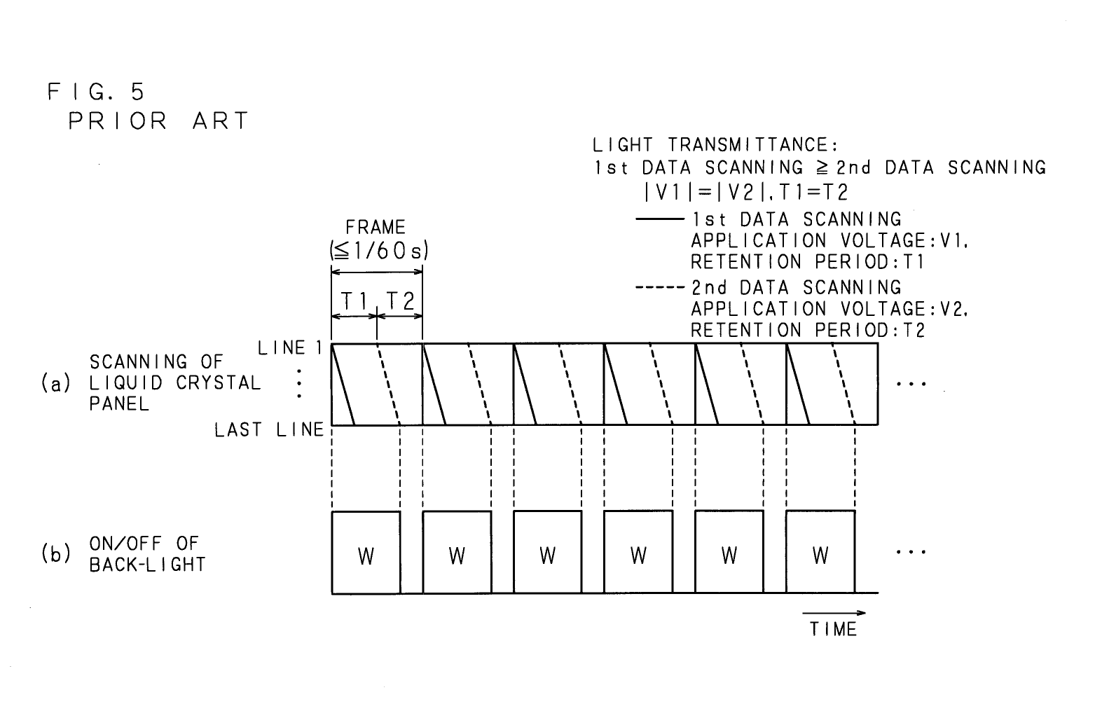

FIG. 6 is a view showing one example of a drive sequence of a liquid crystal display device of a field sequential type of the present invention;

FIG. 7 is a view showing one example of a drive sequence of a liquid crystal display device of a color filter type of the present invention;

FIG. 8 is a table showing an observation result of a presence or absence of an image sticking;

FIG. 9 is a table showing an observation result of a presence or absence of an image sticking;

FIG. 10 is a table showing an observation result of a presence or absence of an image sticking;

FIG. 11 is a block diagram showing a circuit structure of a liquid crystal display device according to a first embodiment (field sequential type);

FIG. 12 is a schematic cross sectional view of a liquid crystal panel and a back-light in the liquid crystal display device according to the first embodiment;

FIG. 13 is a diagrammatic view showing an overall structure of the liquid crystal display device according to the first embodiment;

FIG. 14 is a block diagram showing a circuit structure of a liquid crystal display device according to a second embodiment (color filter type);

FIG. 15 is a schematic cross sectional view of a liquid crystal panel and a back-light in the liquid crystal display device according to the second embodiment;

FIG. 16 is a diagrammatic view showing an overall structure of the liquid crystal display device according to the second embodiment; and

FIG. 17 is a view showing another example (example 4) of the drive sequence of the liquid crystal display device of the color filter type of the present invention.

### EXPLANATION OF REFERENCE NUMERALS

2 Glass Substrate
3 Common Electrode
4 Glass Substrate
13 Liquid Crystal Layer
21 Liquid Crystal Panel
22 Back-Light
31 Control Signal Generation circuit
32 Data Driver
33 Scan Driver
34 Reference voltage Generation circuit
40 Pixel Electrode
41 TFT
42 Signal Line
43 Scan Line
50 Driver unit
60 Color Filter

### BEST MODE OF IMPLEMENTING THE INVENTION

The present invention is specifically explained with reference to the drawings illustrating some embodiments thereof. Note that the present invention is not limited to the following embodiments.

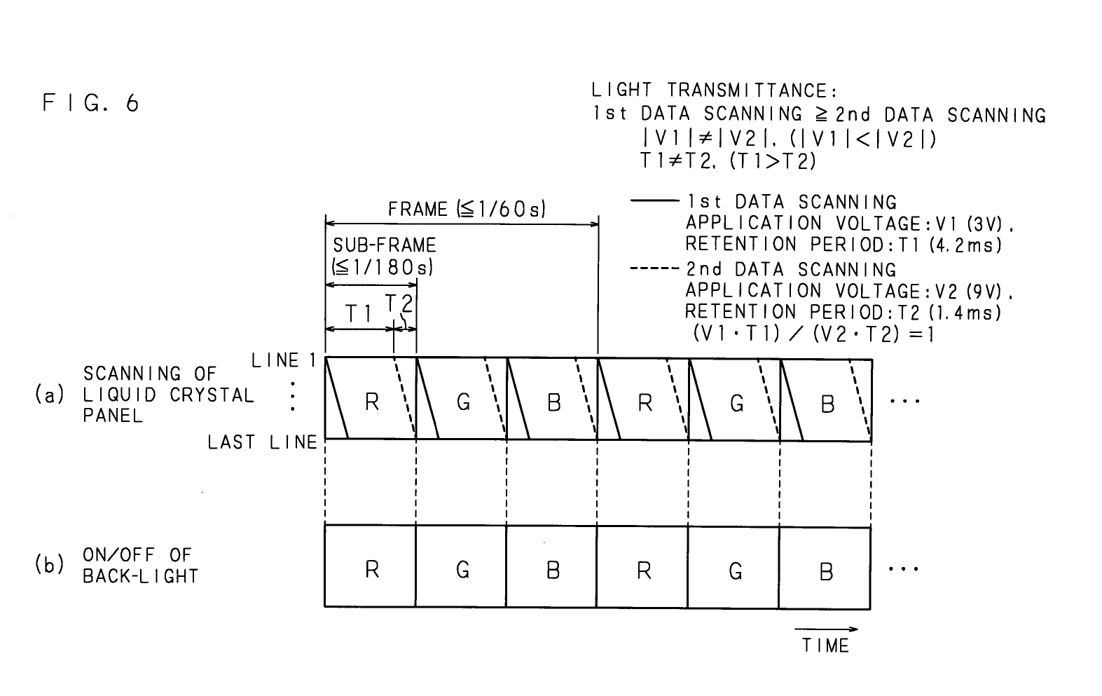

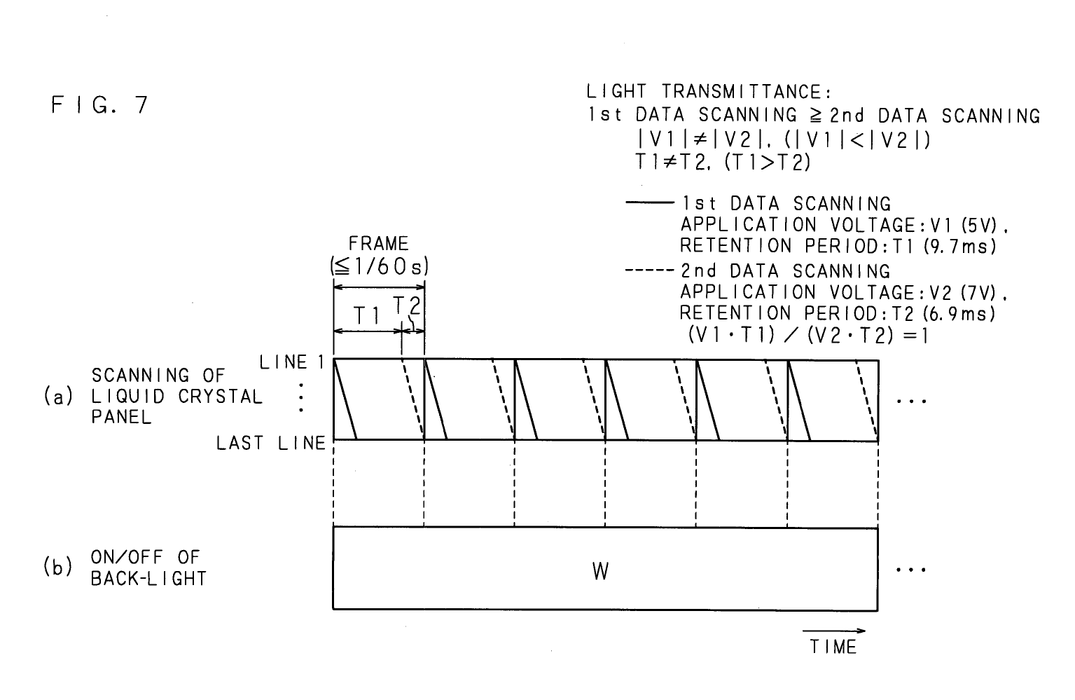

At first, the schema of the present invention is explained by using the drive sequence shown in FIG. 6 and FIG. 7. FIG. 6 shows one example of the drive sequence of the liquid crystal display device of the field sequential type of the present invention, and FIG. 7 shows one example of the drive sequence of the liquid crystal display device of the color filter type of the present invention.

In the present invention, as shown in FIG. 6 and FIG. 7, between an application voltage of one polarity and an application voltage of the other polarity is different in value, and respective retention periods are different. That is, in FIG. 6 and FIG. 7, a value V1 of the application voltage corresponding to a display data and a value V2 of the application voltage to carry out a substantially black image is different (|V1|≠|V2|). Also, a retention period T1 until the application of the voltage to carry out the substantially black image after the application of the voltage corresponding to the display data is different from a retention period T2 until the application of the voltage corresponding to the display data after the application of the voltage to carry out the substantially black image (T1≠T2). It is noted that the potential of the liquid crystal in this retention period is not always constant because of the influence caused by the response of the liquid crystal material and the like.

For example, in the case a scan cycle of data is assumed to be 25% of one sub-frame or one frame (FIG. 6, FIG. 7), about ¾ (75%) of the light emission quantity of the back-light can be used for the displaying. Thus, as compared with the conventional example, the light usage efficiency of the back-light can be increased. The present invention can improve the light usage efficiency of the back-light as mentioned above. Thus, in the case of the same screen brightness, the power consumption can be reduced. Also, if the screen brightnesses and the power consumptions are equal, the installation number of light sources such as LED (Laser Emitting Diode) and the like can be reduced, thereby attaining the lower cost.

The application voltage V2 (9 V in the example of FIG. 6) at the polarity at which the dark displaying is carried out (the second data scanning) is made greater than the application voltage V1 (3 V in the example of FIG. 6) at the polarity at which the bright displaying is carried out correspondingly to the image data (the first data scanning), and the former retention period T2 (1.4 ms in the example of FIG. 6) is made shorter than the latter retention period T1 (4.2 ms in the example of FIG. 6). Consequently, in the period while the back-light is lighted up, the period of the dark displaying that can be regarded to be the black image, namely, the period where the back-light that does not contribute to the displaying can be made shorter. Thus, the light usage efficiency of the back-light can be made higher, thereby attaining the smaller power consumption and the lower cost.

A multiplication value V1·T1 (12.6 in the example of FIG. 6) between the foregoing V1 and T1 and a multiplication value V2·T2 (12.6 in the example of FIG. 6) between the foregoing V2 and T2 are made equal. Thus, the imbalance of charges between the time of the voltage application of the one polarity and the time of the voltage application of the other polarity can be suppressed, thereby protecting the image sticking.

The value of (V1·T1)/(V2·T2) is preferred to be in a range between 0.7 and 1.3, and the further preferable range is between 0.9 and 1.1. This reason will be explained below.

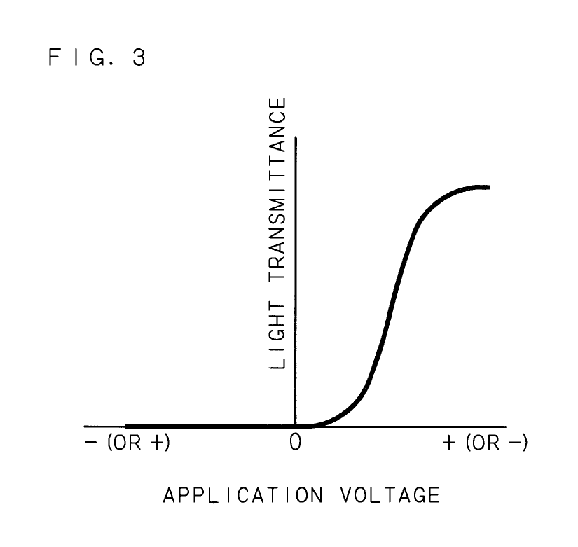

After the TFT substrate having the pixel electrodes (the number of the pixels of 640×480, the diagonal of 3.2 inches) and the glass substrate having the common electrode were washed, polyimide was coated, and they were baked at 200° C. for an hour. Consequently, polyimide films of about 200 Å were formed. Moreover, those polyimide films were rubbed with a cloth made of rayon, and those two substrates were stacked on each other so that the rubbing directions were parallel. Then, they were stacked on each other in the situation that gap was held with the spacer made of silica having an average particle diameter of 1.6 μm between them, and an empty panel was produced. A ferroelectric liquid crystal material of a mono-stable type (made by Clariant Japan: R2301) indicating the electro-optic response characteristic of the half-V-shape shown in FIG. 3 was sealed in this empty panel. The magnitude of the spontaneous polarization of the sealed liquid crystal material was 6 nC/cm². Also, after it was sealed, a DC voltage of 3 V was applied with a transition point of a Chiral-Smectic C phase from a Cholesteric phase between, and the uniform liquid crystal alignment state is realized (alignment process). The produced panel was sandwiched between the two polarization films in crossed-Nicol states, and the liquid crystal panel was defined. Then, when the voltage was not applied, it was made in the dark state.

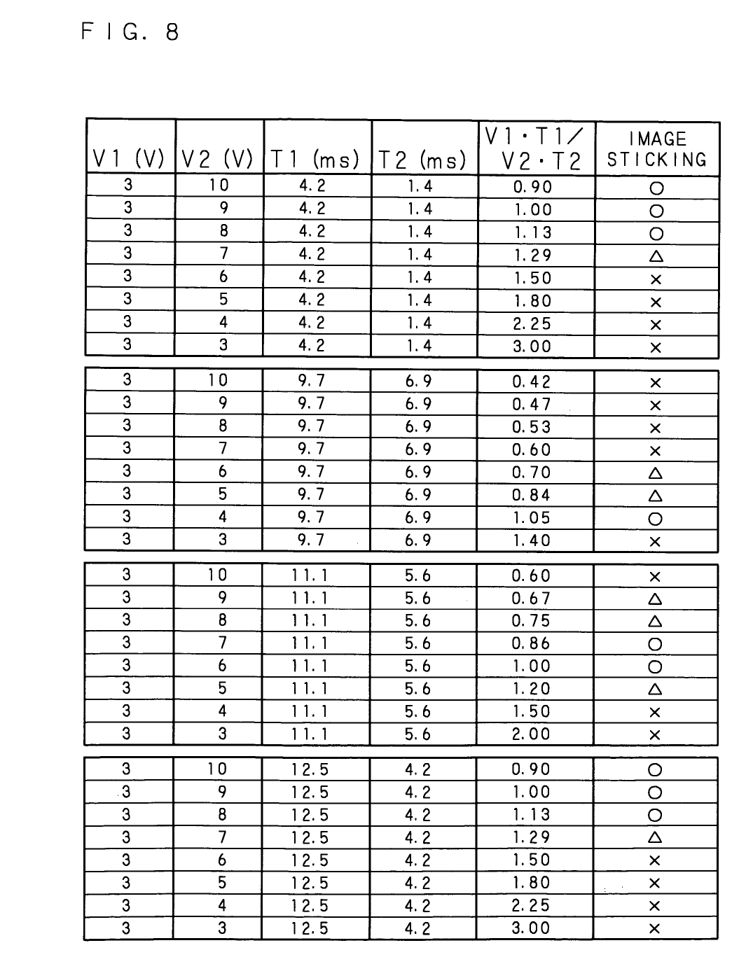

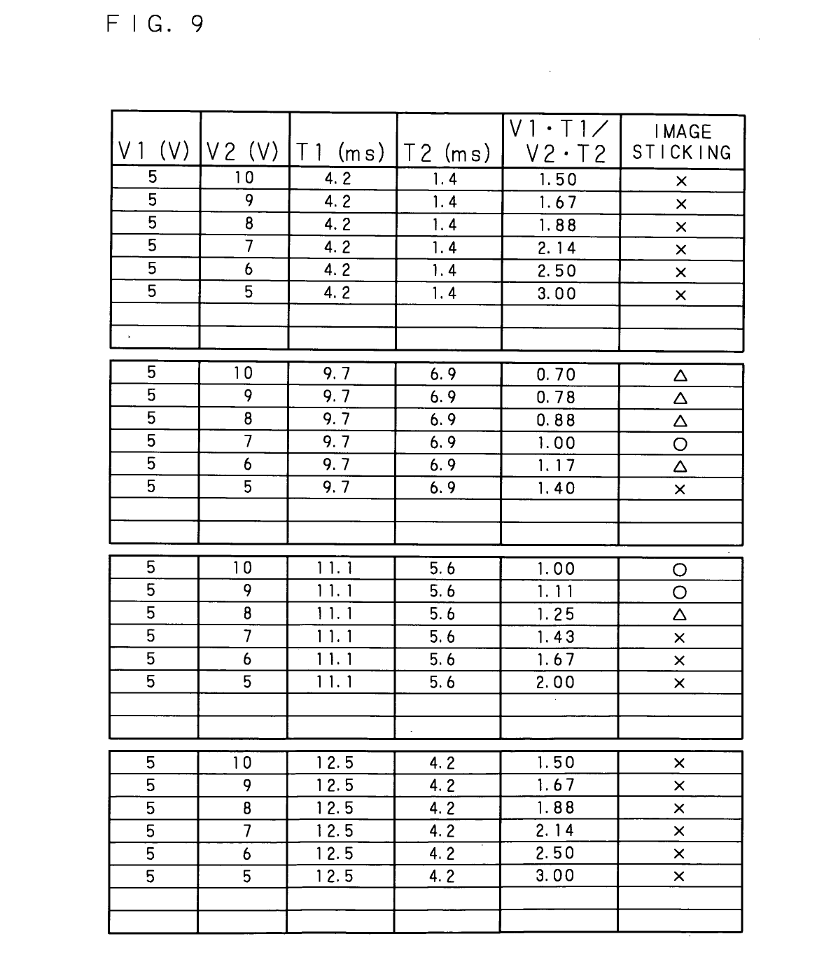

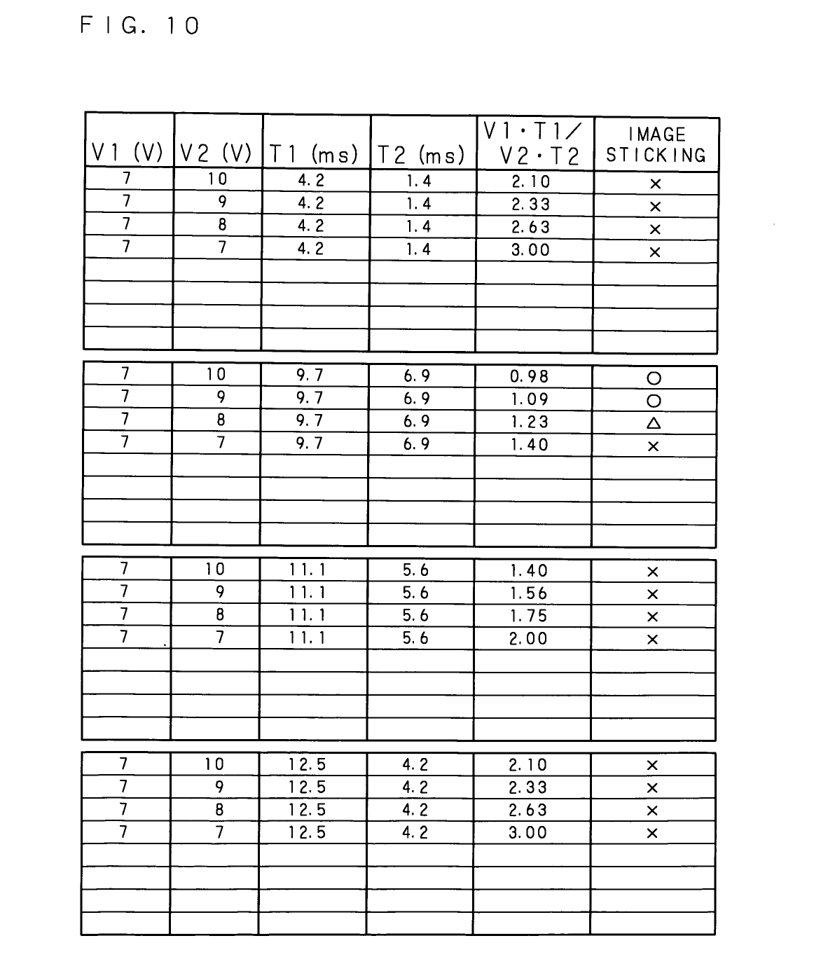

The thus-produced liquid crystal panel and the back-light, which enabled the monochrome surface light emission switching of red, green and blue, were stacked on each other, and while V1, V2, T1 and T2 were changed, white/black checkerwise displaying was carried out for two hours, in accordance with the drive sequence as shown in FIG. 6, and whether or not the image sticking was induced was observed. The observation result was shown in FIG. 8, FIG. 9 and FIG. 10. In FIG. 8 to FIG. 10, ◯ indicates the case that the image sticking was not recognized, Δ indicates the case that, although the image sticking was slightly recognized, this case has no problem on actual use, and X indicates the case that the image sticking was recognized which might lead to a problem.

From the result of FIG. 8 to FIG. 10, since the value of (V1·T1)/(V2·T2) is set to be in the range between 0.7 and 1.3, it is known that the image sticking can be suppressed. Also, it is known that the range of this value is further desired to be between 0.9 and 1.1.

### First Embodiment

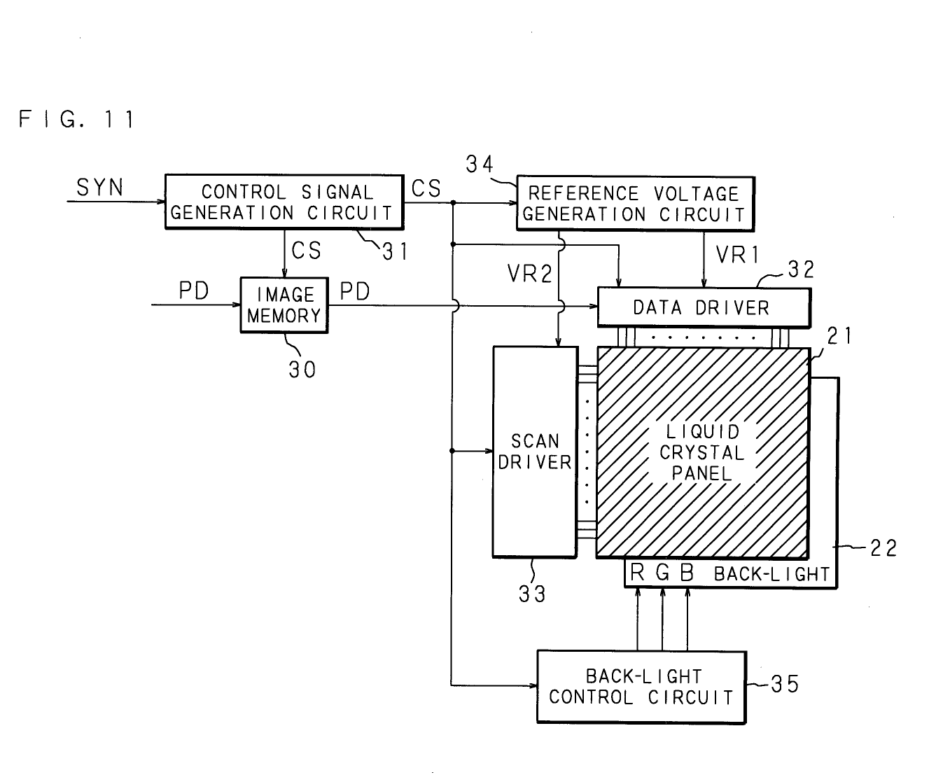

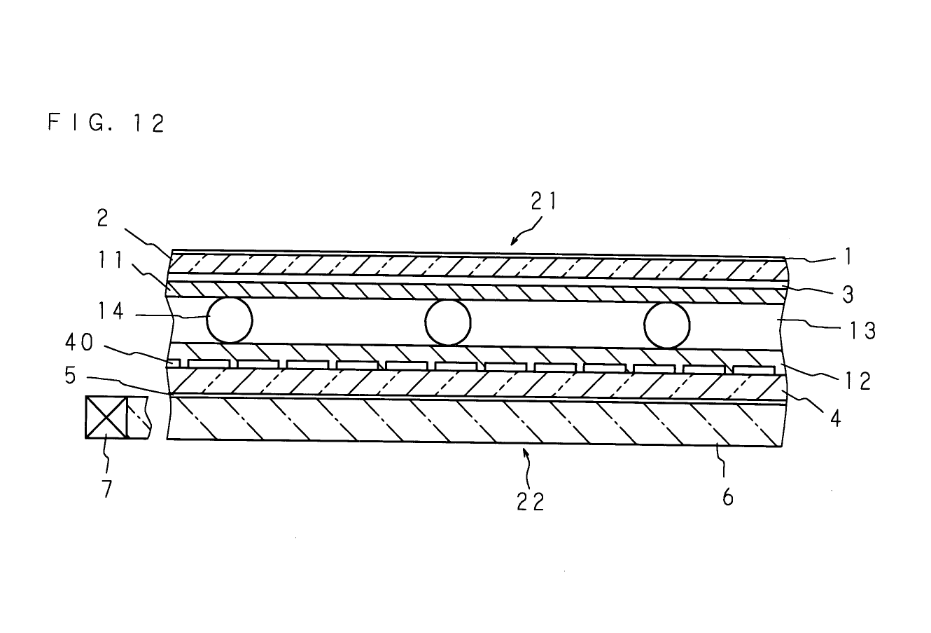

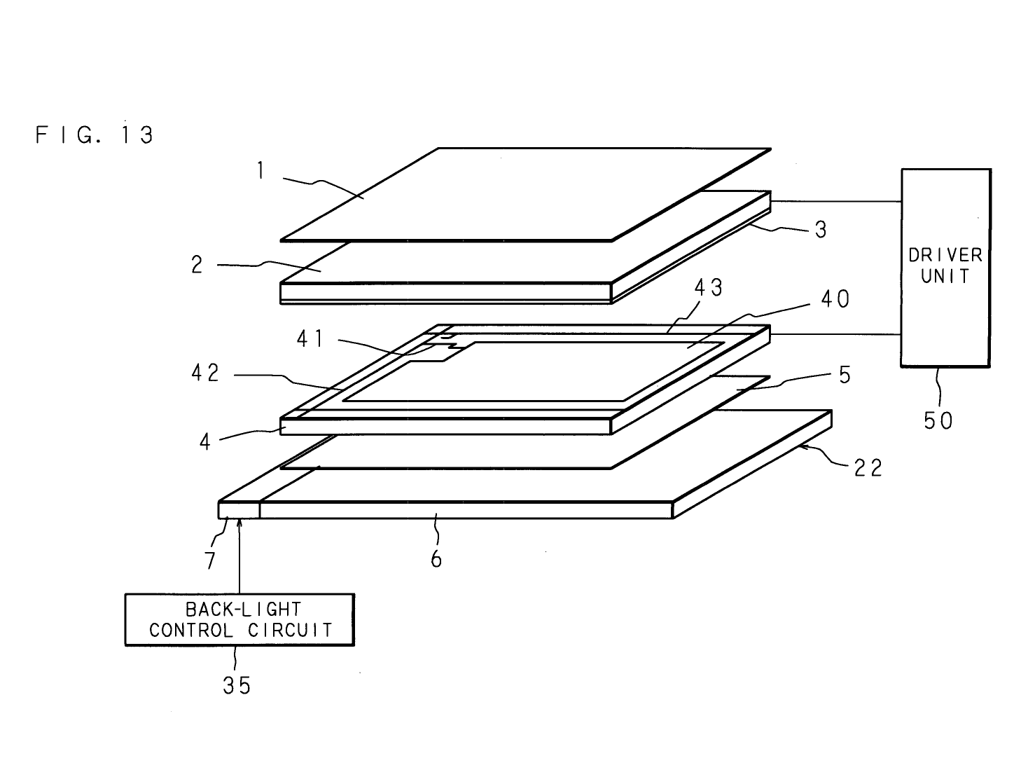

FIG. 11 is a block diagram showing the circuit structure of a liquid crystal display device according to the first embodiment of the present invention. FIG. 12 is a schematic cross sectional view of a liquid crystal panel and a back-light. And, FIG. 13 is a diagrammatic view showing the overall structure of the liquid crystal display device. The first embodiment is the liquid crystal display device that carries out the color displaying by using the field sequential method.

In FIG. 11, the numerals 21, 22 represent a liquid crystal panel and a back-light whose sectional structures are shown in FIG. 12. As shown in FIG. 12, the back-light 22 is composed of an LED array 7 and a light guiding/diffusing plate 6. As shown in FIG. 12 and FIG. 13, the liquid crystal panel 21 is configured such that a polarization film 1, a glass substrate 2, a common electrode 3, a glass substrate 4 and a polarization film 5 are stacked in this order from the upper layer (surface) side to the lower layer (rear) side. Pixel electrodes 40, 40 - - - arranged in a matrix form are formed on the surface of the common electrode 3 side of the glass substrate 4.

A driver unit 50 that is composed of a data driver 32, a scan driver 33 and the like is connected between the common electrode 3 and the pixel electrodes 40, 40 - - - . The data driver 32 is connected through the signal line 42 to the TFT 41, and the scan driver 33 is connected through the scan line 43 to the TFT 41. The TFT 41 is controlled so as to be turned on and off by the scan driver 33. Also, the individual pixel electrodes 40, 40 - - - are connected to the TFT 41. Thus, the transmission light intensity of the individual pixel is controlled by the signal (data voltage) from the data driver 32 that is given through the signal line 42 and the TFT 41.

An alignment film 12 is formed on the top surfaces of the pixel electrodes 40, 40 - - - on the glass substrate 4, and an alignment film 11 is formed on the bottom surface of the common electrode 3, respectively. Liquid crystal substances are filled between those alignment films 11, 12 so that a liquid crystal layer 13 is formed. It is noted that the numeral 14 represents a spacer for holding a layer thickness of the liquid crystal layer 13.

The back-light 22 is located on the bottom layer (rear) side of the liquid crystal panel 21 and contains the LED array 7 in the situation placed to face the end surface of the light guiding/diffusing plate 6 constituting a light emitting area. This LED array 7 has one or a plurality of LEDs, in which the LED elements for emitting the lights of three primary colors, namely, the respective colors of red, green and blue are defined as one chip, on the surface opposite to the light guiding/diffusing plate 6. Then, in the respective sub-frames of red, green and blue, the LED elements of red, green and blue are lighted up, respectively. The light guiding/diffusing plate 6 guides the light emitted from each LED of this LED array 7 to its entire surface, and diffuses to the top surface, thereby functioning as the light emitting area.

This liquid crystal panel 21 and the back-light 22 where the time division light emission of red, green and blue is possible are stacked on each other. The timing when this back-light 22 is lighted up and the light emission color thereof are controlled in synchronization with the data scan based on the display data for the liquid crystal panel 21.

In FIG. 11, the numeral 31 is a control signal generation circuit to which a synchronous signal SYN is inputted from a personal computer and which generates various control signals CS necessary for the displaying. An image memory 30 outputs a pixel data PD to the data driver 32. A voltage is applied through the data driver 32 to the liquid crystal panel 21, in accordance with the pixel data PD and the control signal CS for changing the polarity of the application voltage.

Also, the control signal generation circuit 31 outputs the control signal CS to a reference voltage generation circuit 34, the data driver 32, the scan driver 33 and a back-light control circuit 35, respectively. The reference voltage generation circuit 34 generates reference voltages VR1 and VR2 and outputs the generated reference voltages VR1 and VR2 to the data driver 32 and the scan driver 33, respectively. The data driver 32 outputs the signal (data voltage) to the signal line 42 of the pixel electrode 40, in accordance with the pixel data PD from the image memory 30 and the control signal CS from the control signal generation circuit 31. In synchronization with the output of this signal, the scan driver 33 sequentially scans the scan line 43 of the pixel electrode 40 for each line. Also, the back-light control circuit 35 applies the drive voltage to the back-light 22 so that red light, green light and blue light are emitted from the back-light 22, respectively.

The operation of the liquid crystal display device will be described below. The pixel data PD for the displaying is inputted from the personal computer to the image memory 30. The image memory 30 once stores this pixel data PD and then outputs this pixel data PD, when receiving the control signal CS outputted from the control signal generation circuit 31. The control signal CS generated by the control signal generation circuit 31 is sent to the data driver 32, the scan driver 33, the reference voltage generation circuit 34 and the back-light control circuit 35. The reference voltage generation circuit 34, when receiving the control signal CS, generates the reference voltages VR1 and VR2 and outputs the generated reference voltages VR1 and VR2 to the data driver 32 and the scan driver 33, respectively.

The data driver 32, when receiving the control signal CS, outputs the signal (data voltage) to the signal line 42 of the pixel electrode 40, in accordance with the pixel data PD outputted from the image memory 30. The scan driver 33, when receiving the control signal CS, sequentially scans the scan line 43 of the pixel electrode 40 for each line. In accordance with the signal (data voltage) from the data driver 32 and the scanning of the scan driver 33, the TFT 41 is driven, and the voltage is applied to the pixel electrode 40, and the transmission light intensity of the pixel is controlled. The back-light control circuit 35, when receiving the control signal CS, supplies the drive voltage to the back-light 22, and performs the time division on the LED elements of the respective colors composed of red, green and blue that are possessed by the LED array 7 of the back-light 22, and the light is generated, and the red light, green light and blue light are sequentially emitted with time. In this way, the lighting-up control of the back-light 22 (the LED array 7) for outputting the incident light to the liquid crystal panel 21 and the plural data scannings to the liquid crystal panel 21 are made synchronous with each other, and the color displaying is carried out.

The specific examples will be described below.

### EXAMPLE 1

After the TFT substrate having the pixel electrodes 40, 40 - - - (the number of the pixels of 640×480, the diagonal of 3.2 inches) and the glass substrate 2 having the common electrode 3 were washed, polyimide was coated, and they were baked at 200° C. for an hour. Consequently, polyimide films of about 200 Å were formed as the alignment films 11, 12. Moreover, those alignment films 11, 12 were rubbed with a cloth made of rayon, and those two substrates were stacked on each other so that the rubbing directions were parallel. Then, they were stacked on each other in the situation that gap was held with the spacer 14 made of silica having an average particle diameter of 1.6 μm between them, and an empty panel was produced. A ferroelectric liquid crystal material (for example, a material disclosed in A. Mochizuki et. al. Ferroelectrics, 133,353 (1991)) whose main component was a naphthalene-based liquid crystal indicating an electro-optic response characteristic of a half-V-shape shown in FIG. 3 was sealed between those alignment films 11, 12 of this empty panel, and the liquid crystal layer 13 was formed. The magnitude of the spontaneous polarization of the sealed ferroelectric liquid crystal material was 10 nC/cm². The produced panel was sandwiched between the two polarization films 1, 5 in crossed-Nicol states, and the liquid crystal panel 21 was defined. Then, when the long-axis direction of ferroelectric liquid crystal molecules was tilted in one way, this was designed so as to be in a dark state.

The thus-produced liquid crystal panel 21 and the back-light 22, where the LED array 7 that enabled the monochrome surface light emission switching of red, green and blue was used as the light source, were stacked on each other, and the color displaying based on the field sequential method was carried out in accordance with the drive sequence shown in FIG. 6. Specifically, they were defined such that V1=3 V, V2=9 V, T1=4.2 ms and T2=1.4 ms. Thus, (V1·T1)/(V2·T2)=1 was obtained.

As a result, the high resolution, high speed response and high color purity displaying could be attained at the same time. There was no image sticking.

### EXAMPLE 2

A ferroelectric liquid crystal material of a mono-stable type (made by Clariant Japan: R2301) indicating the electro-optic response characteristic of the half-V-shape shown in FIG. 3 was sealed between those alignment films 11, 12 of this empty panel produced in the process similar to the example 1, and the liquid crystal layer 13 was formed. The magnitude of the spontaneous polarization of the sealed liquid crystal material was 6 nC/cm². Then, after it was sealed, a DC voltage of 3 V was applied with a transition point of a Chiral-Smectic C phase from a Cholesteric phase between, and the uniform liquid crystal alignment state is realized (alignment process). The produced panel was sandwiched between the two polarization films 1, 5 in the crossed-Nicol state, and the liquid crystal panel 21 was defined. Then, when the voltage was not applied, this was designed so as to be in the dark state.

The thus-produced liquid crystal panel 21 and the back-light 22 similar to the example 1 were stacked on each other, and the color displaying based on the field sequential method was carried out in accordance with the drive sequence shown in FIG. 6. Specifically, they were defined such that V1=4 V, V2=10 V, T1=4.2 ms and T2=1.4 ms. Thus, (V1·T1)/(V2·T2)=1.2 was obtained.

As a result, the high resolution, high speed response and high color purity displaying could be attained at the same time. There was no image sticking.

### Second Embodiment

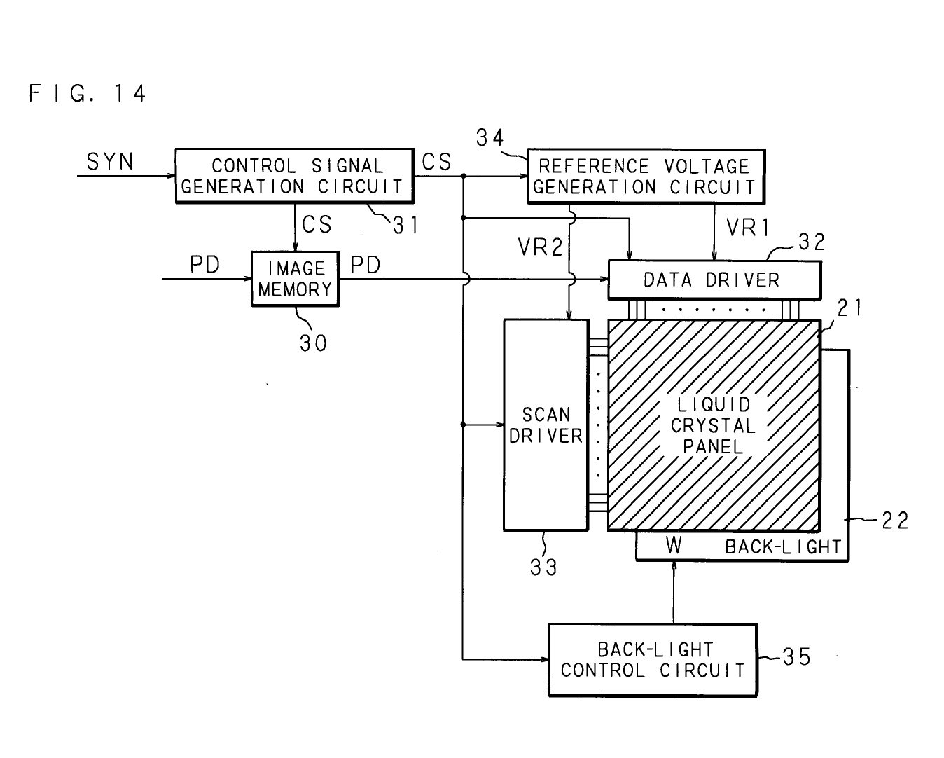

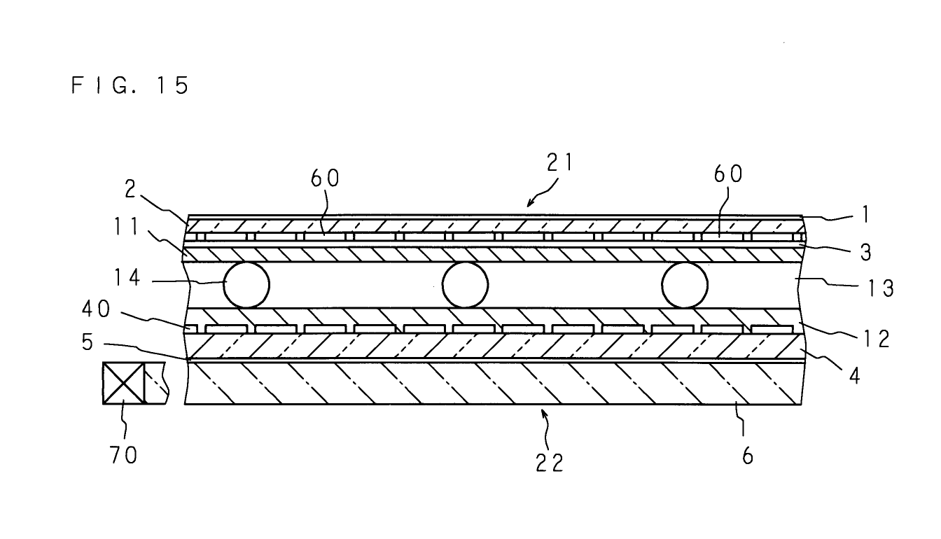

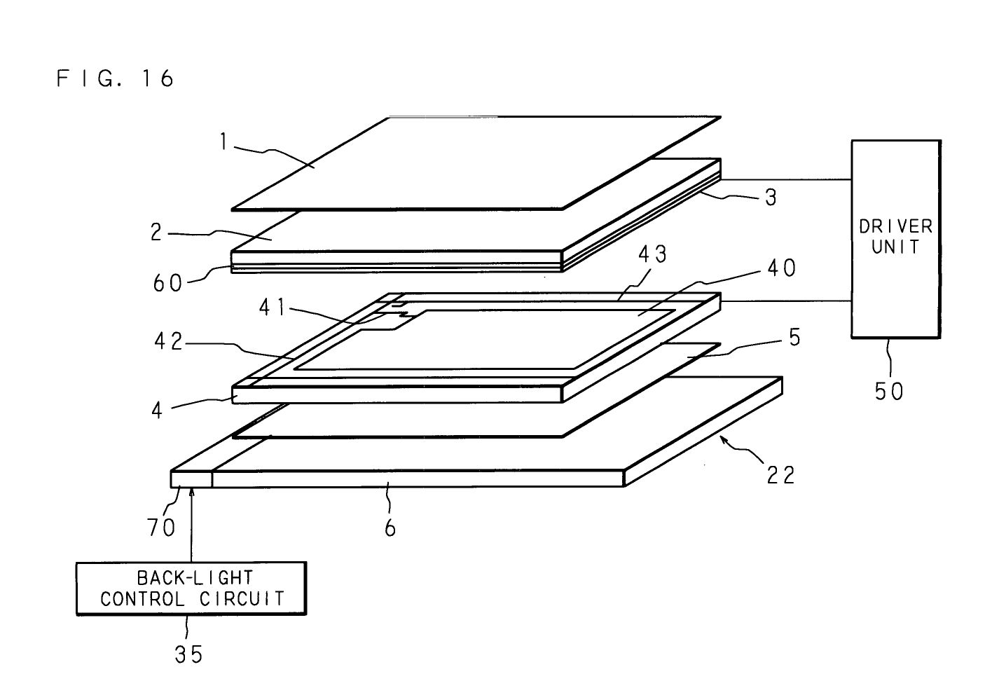

FIG. 14 is a block diagram showing the circuit structure of the liquid crystal display device according to the second embodiment of the present invention, FIG. 15 is a schematic cross sectional view of the liquid crystal panel and the back-light, and FIG. 16 is a diagrammatic view showing the overall structure of the liquid crystal display device. The second embodiment is the liquid crystal display device for carrying out the color displaying based on the color filter method. In FIG. 14 to FIG. 16, the same symbols are assigned to the portions equal or similar to FIG. 11 to FIG. 13.

Color filters 60, 60 - - - for the three primary colors (R, G and B) are installed in the common electrode 3. Also, the back-light 22 is composed of: a white light source 70 containing one or a plurality of white light source elements for outputting white lights; and the light guiding/diffusing plate 6. In the liquid crystal display device of such a color filter type, the white light emission from the white light source 70 which enables the time division light emission of the white light is selectively transmitted through the color filters 60 of a plurality of colors, and the color displaying is carried out.

The specific examples will be described below.

### EXAMPLE 3

After the TFT substrate having the pixel electrodes 40, 40 - - - (the number of the pixels of 320×3(RGB)×240, the diagonal of 3.5 inches) and the glass substrate 2 having the common electrode 3 and the color filter 60 were washed, polyimide was coated, and they were baked at 200° C. for an hour. Thus, the polyimide films of about 200 Å were formed as the alignment films 11, 12. Moreover, those alignment films 11, 12 were rubbed with the cloth made of rayon, and those two substrates were stacked on each other so that the rubbing directions were parallel. Then, they were stacked on each other in the situation that the gap was held with the spacer 14 made of the silica having the average particle diameter of 1.6 μm between them, and the empty panel was produced. The ferroelectric liquid crystal material (for example, the material disclosed in A. Mochizuki et. al.: Ferroelectrics, 133,353 (1991)) whose main component was the naphthalene-based liquid crystal indicating the electro-optic response characteristic of the half-V-shape shown in FIG. 3 was sealed between those alignment films 11, 12 of this empty panel, and the liquid crystal layer 13 was formed. The magnitude of the spontaneous polarization of the sealed ferroelectric liquid crystal material was 10 nC/cm². The produced panel was sandwiched between the two polarization films 1, 5 in the crossed-Nicol states, and the liquid crystal panel 21 was defined. Then, when the long-axis direction of the ferroelectric liquid crystal molecules was tilted in one way, this was designed so as to be in the dark state.

The thus-produced liquid crystal panel 21 and the back-light 22 having the white light source 70 which enabled the time division light emission of the white light were stacked on each other, and the color displaying based on the color filter method was carried out in accordance with the drive sequence shown in FIG. 7. Specifically, they were defined such that V1=5 V, V2=7 V, T1=9.7 ms and T2=6.9 ms. Thus, (V1·T1)/(V2·T2)=1 was obtained.

As a result, the excellent color displaying and the high speed response displaying could be attained, and there was no image sticking.

### EXAMPLE 4

The ferroelectric liquid crystal material of the single stable type (made by Clariant Japan: R2301) indicating the electro-optic response characteristic of the half-V-shape shown in FIG. 3 was sealed between the alignment films 11, 12 of this empty panel produced in the process similar to the example 3, and the liquid crystal layer 13 was formed. The magnitude of the spontaneous polarization of the sealed liquid crystal material was 6 nC/cm². Then, after it was sealed, the DC voltage of 3 V was applied with the transition point of the Chiral-Smectic C phase from the Cholesteric phase between, and the uniform liquid crystal alignment state could be realized (alignment process). The produced panel was sandwiched between the two polarization films 1, 5 in the crossed-Nicol state, and the liquid crystal panel 21 was defined. Then, when the voltage was not applied, this was designed so as to be in the dark state.

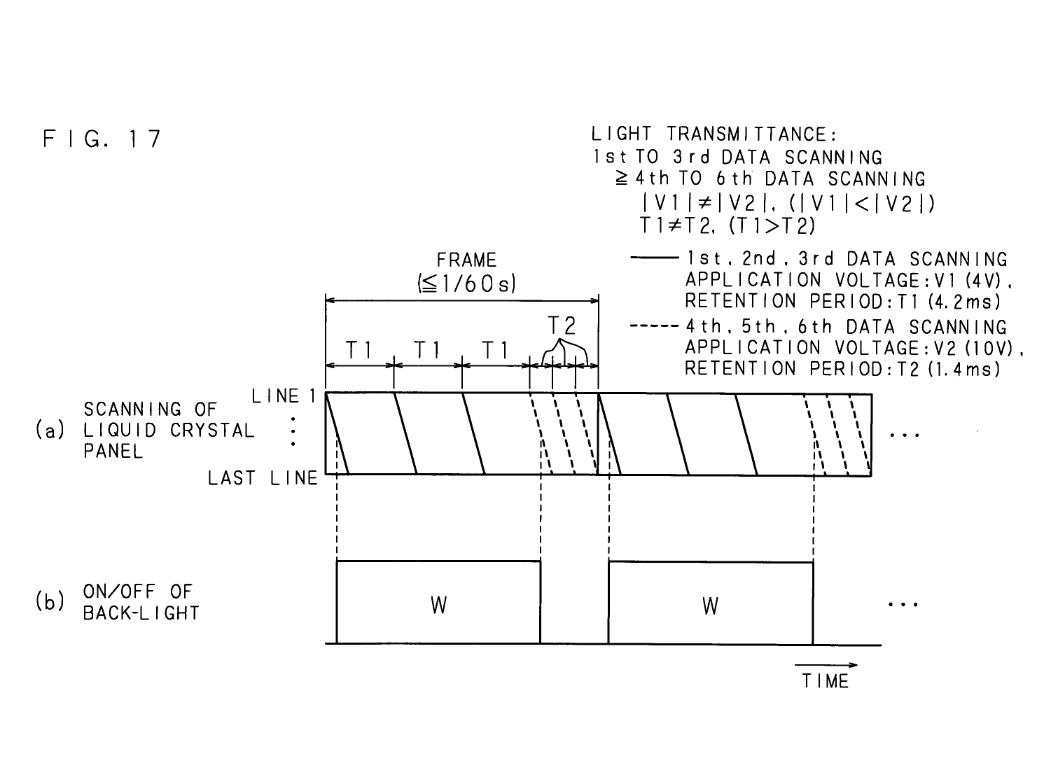

The thus-produced liquid crystal panel 21 and the back-light 22 similar to the example 3 were stacked on each other, and the color displaying based on the color filter method was carried out in accordance with the drive sequence shown in FIG. 17. In this example 4, within one frame, after the scanning based on the application voltage corresponding to the display data was performed continuously three times, the scanning based on the application voltage to carry out the black displaying was performed continuously three times. Also, differently from the examples 1 to 3 where the back-light was lighted up until the scan completion timing based on the voltage of the other polarity after the scan start timing based on the voltage of one polarity in each sub-frame or each frame, in this example 4, the back-light was lighted up until the middle of the first write scanning to carry out the black image after the middle of the first write scanning corresponding to the display data in each frame. The specific values in the example 4 were V1=4V, V2=10V, T1=4.2 ms and T2=1.4 ms. Thus, (V1·T1)/(V2·T2)=1.2 was obtained.

As a result, the excellent color displaying and the high speed response displaying could be attained, and there was no image sticking.

It is noted that the above-mentioned examples have been explained by exemplifying the case of using the ferroelectric liquid crystal material indicating the spontaneous polarization. However, in a case of using a different liquid crystal material indicating the spontaneous polarization, for example, an anti-ferroelectric liquid crystal material, or even in a case of using a nematic liquid crystal material that does not indicate the spontaneous polarization, if the drive display type is similar, it is natural that the effect similar to the case of the ferroelectric liquid crystal material can be obtained.

Moreover, the liquid crystal display device of the transmission type has been explained. However, the present invention can be similarly applied to the liquid crystal display device of the reflection type or half-transmission type. In the case of the liquid crystal display device of the reflection type or half-transmission type, the displaying is possible without any use of the light source such as the back-light and the like. Thus, the power consumption is small.

What is claimed is:

1. A liquid crystal display device, comprising:
a plurality of opposite substrates;
a liquid crystal material sealed in gap composed of said plurality of substrates; and
a voltage application unit for applying voltages whose polarities are different, to said liquid crystal material, plural times within a predetermined period,
wherein a value of the voltage of one polarity that is applied to said liquid crystal material within the predetermined period is different from a value of the application voltage of the other polarity, and a period until the application of the voltage of the other polarity after the application of the voltage of the one polarity is different from a period until the application of the voltage of the one polarity after the application of the voltage of the other polarity.

2. The liquid crystal display device according to claim 1, wherein the value of the voltage of the other polarity when dark displaying is carried out is greater than the value of the voltage of the one polarity when bright displaying is carried out and the period until the application of the voltage of the one polarity after the application of the voltage of the other polarity is shorter than the period until the application of the voltage of the other polarity after the application of the voltage of the one polarity.

3. The liquid crystal display device according to claim 1, wherein V1·T1≈V2·T2 is satisfied.
V1: the value of the voltage of the one polarity
T1: the period until the application of the voltage of the other polarity after the application of the voltage of the one polarity
V2: the value of the voltage of the other polarity
T2: the period until the application of the voltage of the one polarity after the application of the voltage of the other polarity.

4. The liquid crystal display device according to claim 1, wherein 0.7≦(V1·T1)/(V2·T2)≦1.3 is satisfied.
V1: the value of the voltage of the one polarity
T1: the period until the application of the voltage of the other polarity after the application of the voltage of the one polarity
V2: the value of the voltage of the other polarity
T2: the period until the application of the voltage of the one polarity after the application of the voltage of the other polarity.

5. The liquid crystal display device according to claim 1, wherein 0.9≦(V1·T1)/(V2·T2)≦1.1 is satisfied.
V1: the value of the voltage of the one polarity
T1: the period until the application of the voltage of the other polarity after the application of the voltage of the one polarity
V2: the value of the voltage of the other polarity
T2: the period until the application of the voltage of the one polarity after the application of the voltage of the other polarity.

6. The liquid crystal display device according to claim 1, wherein said liquid crystal material is a liquid crystal material having a spontaneous polarization.

7. The liquid crystal display device according to claim 1, wherein color displaying is carried out by using a field sequential method.

8. The liquid crystal display device according to claim 1, wherein color displaying is carried out by using a color filter method.
